(19) United States
(12) Patent Application Publication
(10) Pub. No.: US 2007/0224470 A1
(43) Pub. Date: Sep. 27, 2007

(54) Modular fuel cell

(76) Inventors: Hsi-Ming Shu, Taipei (TW); Ya-Chien Chung, Taipei (TW); Wei-Li Huang, Taoyuan (TW)

Correspondence Address: G. LINK CO., LTD, 3550 Bell Road, MINOOKA, IL, 60447, US

(21) Appl. No.: 11/387,740

(22) Filed: Mar. 24, 2006

(51) Int. Cl. H01M 8/04

(52) U.S. Cl. 429/22; 429/34; 429/24

(57) ABSTRACT

A modular fuel cell is disclosed, which can be assembled with various modular components including a fuel cell module, a control module and a fuel supply module, if desired. The fuel cell module is fabricated by a printed circuit board (PCB) process, and is used to perform an electrochemical reaction and generate power. The control module comprises a PCB and an electric circuit disposed on the PCB. The electric circuit comprises at least an electrical device. The fuel supply module comprises a fuel tank, and at least a pump and/or at least a valve. The pump and/or the valve are controlled by the control module, and at least a pump and/or at least a valve are connected to the fuel cell module.

### FIELD OF THE INVENTION

The present invention relates to a fuel cell, and more particularly, to a modular fuel cell that can be assembled flexibly based on the requirements.

### BACKGROUND OF THE INVENTION

Conventional fuel cells include not only the core components therein but also other mechanical and electrical peripherals, such as fuel tanks, pumps, valves, fans, and circuit devices. Traditionally, the way to assemble these mechanical and electrical peripherals of the fuel cells is to piece together separate mechanical and electrical peripherals. But such assembling method is not applied to mass production. It is also difficult to master quality control over producing fuel cells.

Therefore, an improved modular fuel cell is provided to overcome the aforesaid disadvantages, which can be assembled according to different requirements.

### SUMMARY OF THE INVENTION

It is a primary object of the invention to provide a modular fuel cell that includes modular mechanical and electrical peripherals. Accordingly, a fuel cell can be assembled flexibly.

In accordance with the aforesaid object of the invention, a modular fuel cell is provided. The modular fuel cell comprises a fuel cell module fabricated by a printed circuit board (PCB) process for performing an electrochemical reaction and generating power, a control module comprising a PCB and an electric circuit disposed on the PCB. The electric circuit comprises at least an electrical device. The modular fuel cell also comprises a fuel supply module including a fuel tank, and at least a pump and/or at least a valve. The pump and/or the valve are controlled by the control module, and at least a pump and/or at least a valve are connected to the fuel cell module. Manifold modular components including the fuel cell module, the control module, a sensor module, the fuel supply module, and a flow cycle module are thus assembled to meet different requirements.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a diagram showing the connection of a modular fuel cell according to the first embodiment of the invention;

FIG. 2 illustrates the one-piece structure combining a control module with a fuel supply module according to one embodiment of the invention;

FIG. 3 shows an exemplar of the fuel tank of the invention;

FIG. 4 is a diagram showing the connection of a modular fuel cell according to the second embodiment of the invention; and

FIG. 5 illustrates the one-piece structure combining a control module with a fuel supply module according to another embodiment of the invention.

### DETAILED DESCRIPTION OF THE INVENTION

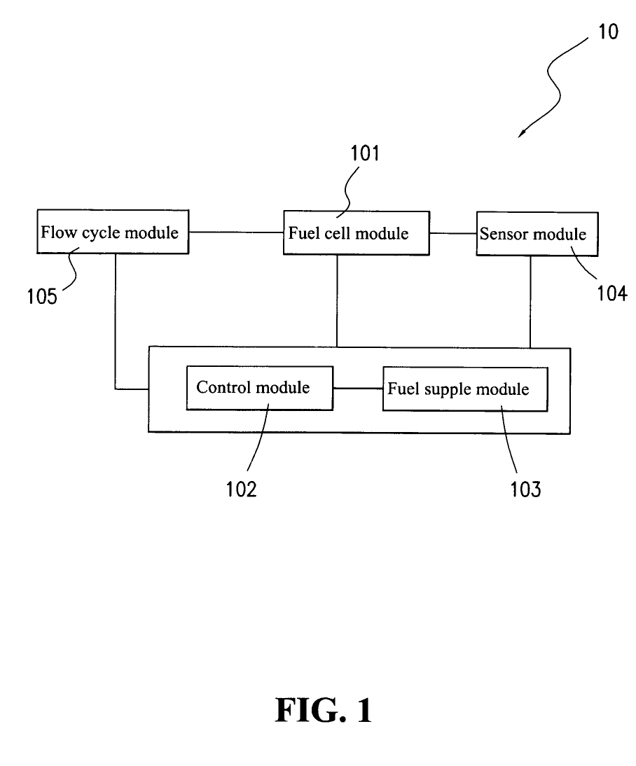

FIG. 1 is a diagram showing the connection of a modular fuel cell according to the first embodiment of the invention. In this embodiment, the device to generate power in a modular fuel cell 10 is a fuel cell module 101. A control module 102, a fuel supply module 103 and a sensor module 104 are regarded as mechanical and electrical peripherals. The fuel cell module 101 includes fuel cells fabricated by printed circuit board (PCB) processes. For example, the fuel cell module 101 contains a direct methanol fuel cell (DMFC). The DMFC uses multi-layers of FR4, epoxy glass fiber substrates, ceramic substrates, polymer plastic substrates, or composite substrates as its stacked substrates, and sandwiches at least a membrane electrode assembly (MEA) in between the stacked substrates for generating power through electrochemical reactions.

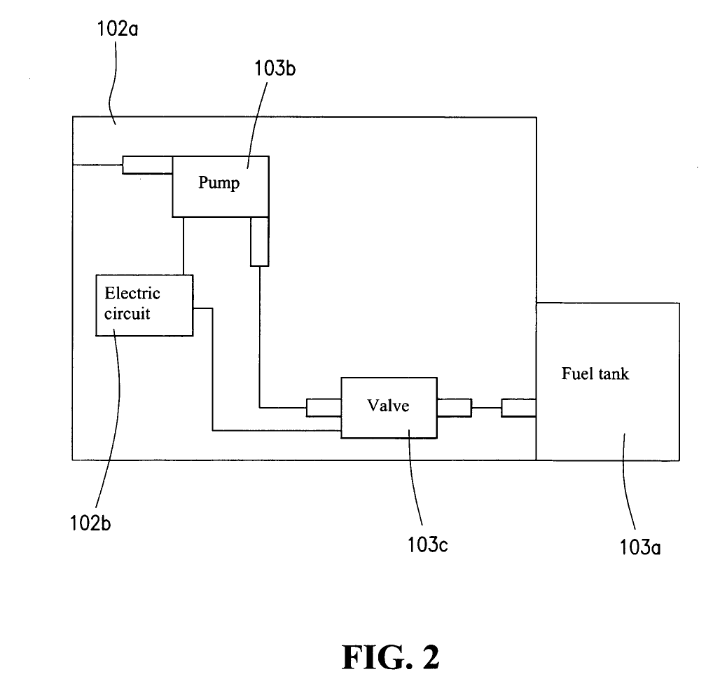

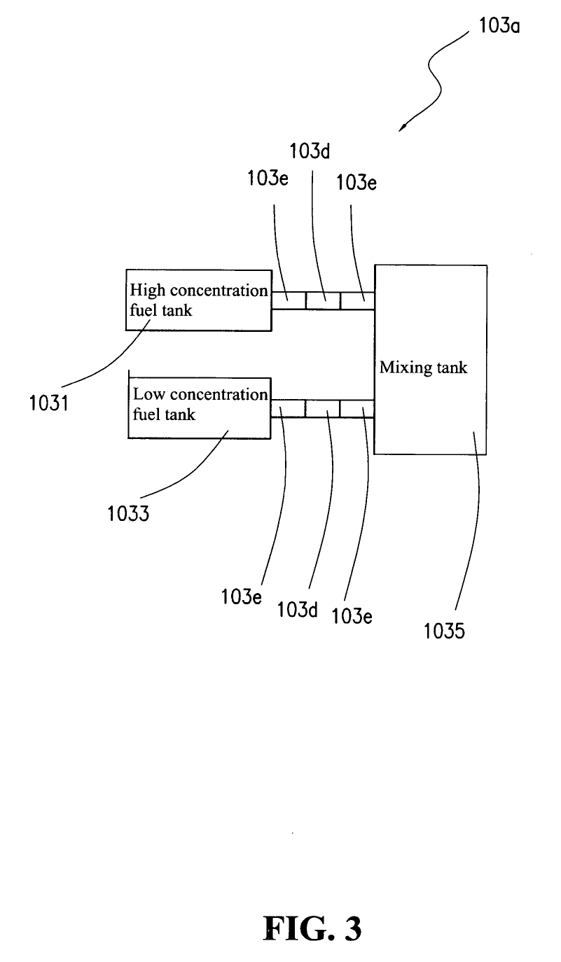

As shown in FIG. 1, the control module 102 and the fuel supply module 103 constitute a one-piece structure. FIG. 2 illustrates the one-piece structure combining a control module with a fuel supply module according to one embodiment of the invention. The one-piece structure is in communication with another fuel cell module 101. The control module 102 comprises a PCB 102a and an electric circuit 102b. The electric circuit 102b is a control circuit including at least an electrical device, and the electrical device comprises a microcontroller. The fuel supply module 103 comprises a fuel tank 103a, a pump 103b and a valve 103c. Fuel within the fuel tank 103a are delivered by the pump 103b, and provided for the fuel cell module 101. The fuel tank 103a may be a single tank. Alternatively, the fuel tank 103a may include a high concentration fuel tank 1031, a low concentration fuel tank 1033 and a mixing tank 1035 with reference to FIG. 3. The mixing tank 1035 is connected to the high concentration fuel tank 1031 and the low concentration fuel tank 1033, respectively, through the pumps 103d and valves 103e. The pumps 103d or valves 103e connected among the mixing tank 1035, the high concentration fuel tank 1031 and the low concentration fuel tank 1033 are controlled by the control module 102. The pump 103b and the valve 103c are electrically coupled to the control module 102, and controlled by the control module 102. Because the control module 102 controls the pump 103b and the valve 103c, the fuel within a single fuel tank 103a or within the mixing tank 1035 are supplied for the fuel cell module 101 at a certain flow rate.

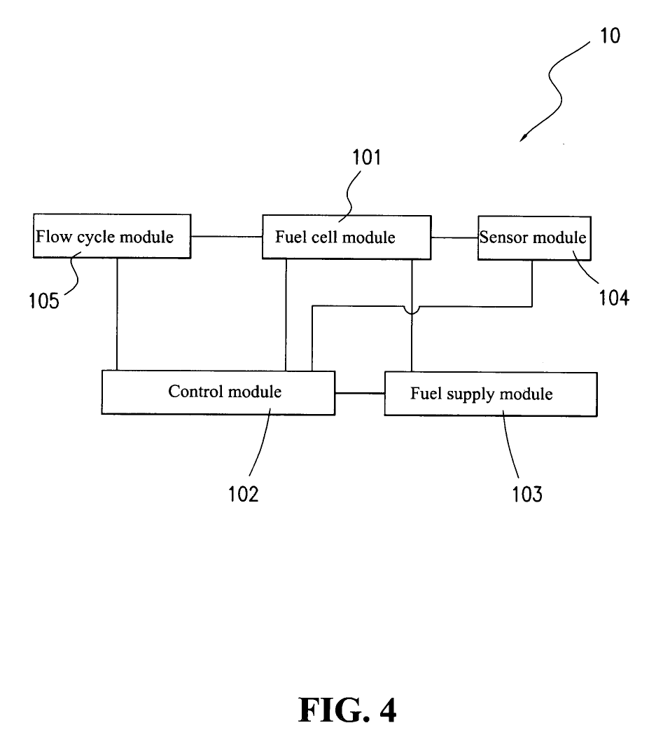

FIG. 4 shows the connection of a modular fuel cell according to the second embodiment of the invention. In FIG. 4, the control module 102 and the fuel supply module 103 are independent elements, but connected to each other. Other components for constructing the control module 102 and the fuel supply module 103 are similar to those described in the first embodiment.

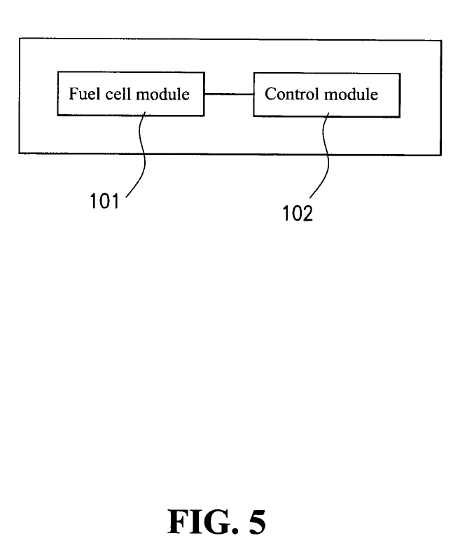

Reference is made to FIG. 5, which illustrates another exemplar based on the second embodiment. Since the fuel supply module 103 is a fuel cell fabricated by PCB processes, the control module 102 and the fuel cell module 101 can share the same substrate, so as to form a one-piece structure.

According to the first and second embodiments, the modular fuel cell 10 further comprises a sensor module 104 for detecting the amount and the concentration of fuel in the fuel cell module 101, and transmitting detective signals to the control module 102. After determining the received signals, the control module 102 controls the pump 103b to regulate the flow rate of fuel. The sensor module 104 comprises a quantity sensor and a concentration sensor. Those sensors are disposed inside the fuel cell module 101.

According to the first and second embodiments, the sensor module 104 may include at least a temperature sensor for measuring the temperature of an operated fuel cell module 101. The temperature sensor is electrically connected with the control module 102. The temperature sensor is, for example, a thermal coupler or a thermal sensitive resistor.

According to the first and second embodiments, the modular fuel cell 10 further comprises a flow cycle module 105 for adjusting temperatures of the fuel cell module 101 and conditions in an operated flowing field. The flow cycle module 105 is electrically connected to the control module 102, and is controlled by the control module 102. The flow cycle module 105 may include a fan, a heat pipe, a water-cooling system, and so on.

The control module 102 receives temperature signals from a temperature sensor, and controls the flow cycle module 105 in accordance with factual temperatures. Hence, adequate temperature is provided for the fuel cell module 101 to perform electrical reactions efficiently.

According to the first and second embodiments, the control module 102 also comprises a power-integrating circuit for regulating power generated by the fuel cell module 101 and then outputting steady specific voltage.

One feature of the modular fuel cell 10 consists in the modular structures of the fuel cell module 101, the control module 102, the fuel supply module 103, the sensor module 104, and the flow cycle module 105. Users may arrange various modular elements to assemble a desired fuel cell 10, depending on different requirements.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and detail may be made therein without departing from the spirit and scope of the invention, as set forth in the following claims.

What is claimed is:

1. A modular fuel cell, comprising:
a fuel cell module fabricated by a printed circuit board (PCB) process for performing an electrochemical reaction and generating power;
a control module including a PCB and an electric circuit disposed on the PCB, wherein the electric circuit comprises at least an electrical device; and
a fuel supply module including a fuel tank, and one or more pumps and/or one or more valves, wherein the pumps and/or the valves are connected to the control module and are controlled by the control module, and at least a pump and/or at least a valve are connected to the fuel cell module.

2. The modular fuel cell of claim 1, wherein the electrical device comprises a microcontroller.

3. The modular fuel cell of claim 1, wherein the fuel tank comprises a high concentration fuel tank, a low concentration fuel tank and a mixing tank.

4. The modular fuel cell of claim 1, wherein a pump connected to the fuel cell module is controlled by the control module such that fuel within the fuel tank is provided for the fuel cell module at a determined flow rate.

5. The modular fuel cell of claim 3, wherein the mixing tank is connected with the high concentration fuel tank and the low concentration fuel tank, respectively, and a pump connected to the fuel cell module is controlled by the control module such that mixed fuel inside the mixing tank is provided for the fuel cell module at a determined flow rate.

6. The modular fuel cell of claim 1, wherein both the fuel cell module and the control module use the PCB.

7. The modular fuel cell of claim 1, wherein the control module and the fuel supply module constitute a one-piece structure.

8. The modular fuel cell of claim 1, wherein the control module and the fuel supply module are independent structures.

9. The modular fuel cell of claim 1, further comprising a sensor module for detecting an amount of fuel and/or a concentration of fuel in the fuel cell module, the sensor module is connected to the control module, wherein the control module controls over the pump based on the amount and/or the concentration to regulate a flow rate of fuel within the fuel tank.

10. The modular fuel cell of claim 9, wherein the sensor module comprises a quantity sensor and a concentration sensor.

11. The modular fuel cell of claim 9, wherein the sensor module is disposed inside the fuel cell module.

12. The modular fuel cell of claim 1, wherein the fuel cell module comprises a bipolar fuel cell plate.

13. The modular fuel cell of claim 9 wherein the sensor module further comprises a temperature sensor disposed inside the fuel cell module and connected to the control module.

14. The modular fuel cell of claim 13, wherein the temperature sensor is a thermal coupler or a thermal sensitive resistor.

15. The modular fuel cell of claim 1, further comprising a flow cycle module controlled by the control module to provide an adequate temperature and an operational condition for the fuel cell module.

16. The modular fuel cell of claim 15, wherein the flow cycle module is a fan, a heat pipe, or a cooling system.

17. The modular fuel cell of claim 1, wherein the fuel cell module and the control module are independent structures.
